(19) United States
(12) Patent Application Publication
(10) Pub. No.: US 2007/0011027 A1
(43) Pub. Date: Jan. 11, 2007

(54) Apparatus, system, and method for providing personalized physical fitness instruction and integrating personal growth and professional development in a collaborative accountable environment

(76) Inventor: Michelle Melendez, San Jose, CA (US)

Correspondence Address: KUNZLER & ASSOCIATES, 8 EAST BROADWAY, SUITE 600, SALT LAKE CITY, UT, 84111, US

(21) Appl. No.: 11/482,266

(22) Filed: Jul. 7, 2006

Related U.S. Application Data
(60) Provisional application No. 60/697,342, filed on Jul. 7, 2005.

(51) Int. Cl. G06Q 10/00; A63B 71/00; G06Q 50/00

(52) U.S. Cl. 705/2; 482/8

(57) ABSTRACT

An apparatus, system, and method are disclosed for integrating physical fitness instruction using a specialized accountability approach and integrating personal growth and professional development in a collaborative accountable environment. The apparatus, in one embodiment, is configured to develop a personalized physical fitness plan from information received from one or more participants in a selected group. The apparatus may be connected to a computer network in order to distribute information, including physical fitness instruction, to participants. In one embodiment, information for personal growth and professional development is integrated with the physical fitness instruction. Alternatively or in addition, information for personal growth and professional development may be provided separately and may be tailored to a participant, group, or company.

### CROSS-REFERENCES TO RELATED APPLICATIONS

This application claims priority to U.S. Provisional Patent Application No. 60/697,342 entitled “APPARATUS, SYSTEM, AND METHOD FOR INTEGRATING PHYSICAL FITNESS INSTRUCTION USING A SPECIALIZED ACCOUNTABILITY APPROACH AND INCLUDING PERSONAL GROWTH AND PROFESSIONAL DEVELOPMENT IN A COLLABORATIVE ENVIRONMENT” and filed on Jul. 7, 2005 for Michelle Melendez, which is incorporated herein by reference.

### BACKGROUND OF THE INVENTION

1. Field of the Invention

This invention relates to physical fitness instruction and motivational programs and more particularly relates to apparatuses, systems, and methods for providing personalized physical fitness instruction using a specialized accountability approach and including directives for personal growth and professional development in a collaborative accountable environment.

2. Description of the Related Art

Many of the health problems facing our society today stem from inactivity and a general lack of regular exercise. People of the working class typically plan their daily activities around routine, job-related responsibilities, which may include working at a desk/computer, standing behind a counter, sitting for long periods of time or other regularly recurring actions that require minimal physical exertion. As a result, many people suffer from chronic conditions such as back and neck pain, wrist strain, stress, anxiety, obesity, depression, lack of motivation, high cholesterol, high blood pressure, and the like.

Studies have shown that a regular exercise program can alleviate the majority of the above-listed health conditions. Yet many people struggle to actually integrate health and wellness principles into their routine activities. Generally, people lack some form of personal goal setting and accountability system to motivate them. In addition, feeling a lack of support from friends and peers can impede personal progress and professional pursuits.

To compound matters, most professional environments fail to provide a structured exercise program and/or physical fitness incentives for their employees. Furthermore, if a corporate exercise program is implemented in the work environment, the program generally fails to meet the personal needs of all individuals involved. As a result, the participants typically lose interest in the program and abandon the program before positive results are realized.

Similarly, motivational programs typically offer information without providing personalized instruction or creating an environment where the individual can apply principles learned. Motivational programs and physical fitness programs are somewhat ineffective without providing an accountability system to determine progress and to receive feedback and encouragement from peers.

From the foregoing discussion, it should be apparent that a need exists for an apparatus, system, and method for integrating physical fitness instruction and personal growth and professional development into a group accountability environment, particularly into an organized work environment. Beneficially, such an apparatus, system, and method would provide a collaborative approach to optimal wellness. In addition, a positive group environment and accountability system would provide individuals with encouragement and support to achieve personal and group goals, thereby enabling individuals to reach their potential physically, socially, and professionally.

### SUMMARY OF THE INVENTION

The present invention has been developed in response to the present state of the art, and in particular, in response to the problems and needs in the art that have not yet been fully solved by currently available physical fitness programs and motivational programs. Accordingly, the present invention has been developed to provide an apparatus, system, and method for integrating physical fitness instruction using a specialized accountability approach and integrating personal growth and professional development in a collaborative accountable environment that overcome many or all of the above-discussed shortcomings in the art.

The apparatus, in one embodiment, is configured to develop a personalized physical fitness plan from information received from one or more participants in a selected group. In certain embodiments, the apparatus includes an input module, an output module, a control module, an integrator module, a storage module, a plan development module, a display module, a charting module, a sequence module, and a calendar module. The apparatus may be connected to a computer network in order to distribute information, including physical fitness instruction, to participants. In one embodiment, information for personal growth and professional development is integrated with the physical fitness instruction. Alternatively or in addition, information for personal growth and professional development may be provided separately and may be tailored to various companies or groups.

The apparatus is further configured, in one embodiment, to receive a response from one or more participants and to chart the response for viewing by multiple participants in a selected group. The chart may be used to visually represent the progress achieved by a participant and/or a group of participants and may further function as a motivator to encourage continued progress. The chart containing personal information may be displayed only to the individual if requested. Alternatively, personal information may be viewable by other participants to encourage collaboration and to provide constructive support.

In one embodiment, the chart is displayed on a webpage for viewing by multiple participants and may be protected by a secure login, password, or the like. In a further embodiment, the chart is emailed to a selected group of participants. Consequently, the participants may encourage others within the group to achieve set goals and to overcome obstacles.

A system of the present invention is also presented to provide one or more tailored personal development plans to an organized group. The system may be embodied in an organized motivational program. In particular, the system, in one embodiment, includes an administrator to receive input from a participant and to develop a plan from the input and to develop a website. In certain embodiments, the administrator may be a personal trainer, an automated control system, and/or a combination of a personal trainer and an automated control system. The plan may include selected information for personal growth and professional development.

A method of the present invention is also presented for integrating physical fitness instruction and personal growth and professional development into a group environment. In one embodiment, the method includes receiving input from a participant in a selected group, developing a personalized plan in response to the input, distributing the plan over a computer network, receiving a response, and charting the response for viewing by one or more participants. The method also includes integrating information for personal growth and professional development.

In a further embodiment, the method includes communicating with the participant. Communication may be initiated through email, chat, telephone, a web forum, a teleseminar, an online class, a web cam, videoconference, or the like in certain embodiments. In one embodiment, an individual, such as a personal trainer, motivational speaker, or another participant in the group, communicates with the participant. In a select embodiment, a fee is associated with contact information to obtain additional information for personal growth and professional development.

In yet another embodiment, the method includes receiving information from a selected group of participants belonging to a larger defined group, developing a tailored plan in response to the information, distributing the tailored plan to one or more participants of the selected group through a computer network, receiving a response from the selected group of participants, and charting the response for comparison with another selected group of participants belonging to the larger defined group. In one embodiment, the selected group comprises individuals employed in a working environment. Competitions between departments or between companies may motivate individuals to contribute to one or more group goals.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

The present invention enables an individual to receive personalized information in order to implement a physical fitness program and to access information for personal growth and professional development. In addition, the present invention provides a collaborative accountable environment to encourage the individual to achieve positive results. These freatures and advantages of the present invention will become more fully apparent form the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a motivational system in accordance with the present invention;

FIG. 2 is a schematic block diagram illustrating one embodiment of an administrator in accordance with the present invention;

FIG. 3 is a schematic block diagram illustrating one embodiment of a membership website in accordance with the present invention;

FIG. 4 is a schematic flow chart diagram illustrating one embodiment of a plan development method in accordance with the present invention; and

FIG. 5 is a schematic flow chart diagram illustrating an alternative embodiment of a plan development method in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

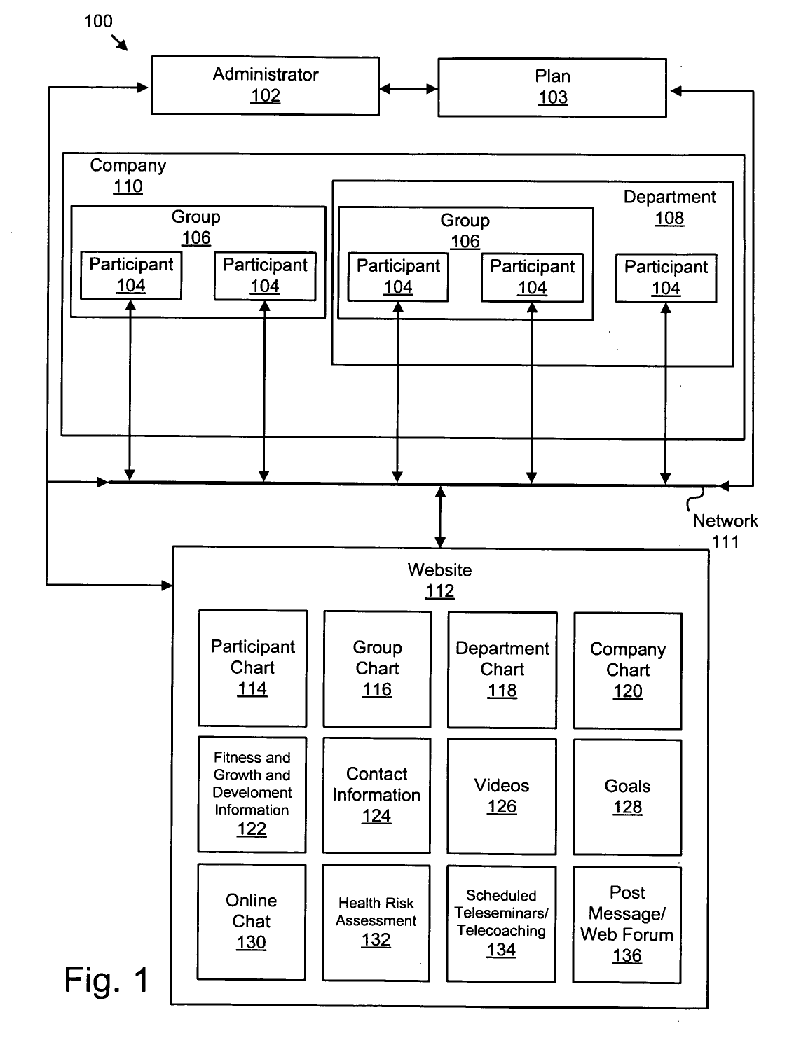

FIG. 1 depicts one embodiment of a motivational system 100 in accordance with the present invention. The motivational system 100, as illustrated, includes an administrator 102, a plan 103, participants 104, groups 106, one or more departments 108, a company 110, a computer network 111, and a website 112. The website 112 may include a participant chart 114, a group chart 116, a department chart 118, a company chart 120, fitness and personal growth and professional development information 122, contact information 124, videos 126, goals 128, online chat capabilities 130, a health risk assessment test 132, scheduled telesiminars and/or telecoaching 134, and a post message and/or web forum 136.

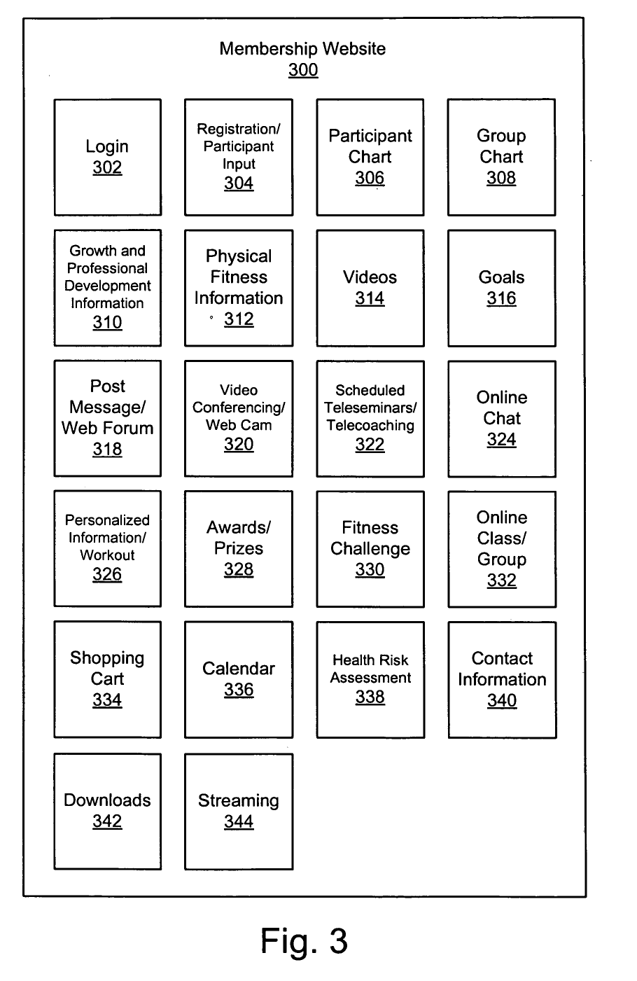

The motivational system 100 provides a framework for distributing a personalized improvement plan 103 to participants 104 within a group 106, 108, 110 through a computer network 111. The website 112 may facilitate collaboration among participants 104 by providing a site for posting and accessing relevant information including the progress charts 114, 116, 118, 120. In addition, the participants 104 may communicate with each other and/or with the administer 102. In certain embodiments, the website 112 may comprise a membership website which will be discussed in greater detail with relation to FIG. 3.

The motivational system 100, in one embodiment, is implemented in a company 110 or corporation to improve morale and wellbeing, including physical fitness. Alternatively, the motivational system 100 may be implemented among any organized group of participants 104 to encourage unity and to increase personal achievement and development. Tailored plans 103 may provide direction to the participant 104 and/or to the group 106, department 108, or company 110. The tailored plan 103 may be customized for individual circumstances and may enable optimal levels of improvement at both the individual and group level.

In certain embodiments, the motivational system 100 provides a goal-oriented and accountability approach to fitness and personal growth and professional development. Charts 114, 116, 118, 120 provide a way for participants 104 to be accountable to other participants 104, or to contribute to the goals of their department 108 and/or company 110. As a result, participants 104 may easily encourage and support each other. In certain embodiments, the goals 128 are directed to personal and professional pursuits. In addition, competition among groups 106, 108, 110 may motivate participates 104 to achieve excellence.

In general, the computer network 111 may comprise a local area network (LAN), a wide area network (WAN), several adjoining networks, an intranet, or a system of interconnected networks such as the Internet or the World Wide Web supported on the Internet. Individual nodes may communicate with each other over a backbone and/or over the Internet with varying degrees and types of communication capabilities and logic capability. Different communication protocols, e.g., ISO/OSI, Internetwork Packet Exchange (IPX), Transmission Control Protocol/Internet Protocol (TCP/IP), may be used on the computer network 111, but in the case of the Internet, a single, layered communications protocol (TCP/IP) generally enables communications between differing networks and nodes. Those skilled in the art, however, will recognize that the invention may be implemented using a variety of computing platforms and/or network architectures. Nodes connected on the network 111 may comprise application servers, web servers, workstations, and/or other resources or peripherals, such as printers and scanners. Other computer networks may be in communication with the computer network 111 through a router and/or over the Internet.

In certain embodiments, the administrator 102 oversees distribution of relevant information to participants 104 either through direct communication over the computer network 111, such as through email communication, or through the website 112. The website 112 may be updated regularly to correspond to the progress and needs of the participants 104 and/or groups 106 and may require a secure login in certain instances. Information may be posted for different levels of accountability, such as participant 104, group 106, department 108, and company 110. In addition, information 122 such as reference materials, videos 126, and the like may be available for download or internet streaming. In certain embodiments, workout videos, personal growth and business development videos, fitness workouts, motivational information, and the like, are available on the website 112 to supplement the information provided through the plan 103.

In certain embodiments, the administrator 102 may communicate with the participant 104 through additional forms of communication, such as personal meetings, telephone contact, online chat 130, postings on the web forum 136, teleseminars or telecoaching sessions 134, online classes, videoconferencing, web cam, and the like. Those of skill in the art will recognize that communication among the participants 104 and communication with the administrator 102 may occur using several available technologies and is not limited to the illustrated embodiments. Communication facilitates providing instruction and enhances collaboration among the participants 104.

In a select embodiment, the administrator 102 comprises one or more personal trainers. Specialized software or the like may facilitate receiving input from a participant 104, developing a personalized or tailored plan 103, distributing the plan 103 through the computer network 11, receiving a response from the participant 104, and charting the response for viewing. The personal trainer may contact the participant 104 to provide personal instruction, to offer encouragement, to answer questions, and to help the participant 104 overcome any obstacles.

In one embodiment, the personal trainer further provides fitness materials for the website 112. For example, the personal trainer may upload fitness videos, customized workouts, motivational material, and the like to the website 112. In addition, the personal trainer may contact motivational speakers or the like to obtain directives and/or information for personal growth and professional development. In one embodiment, the personal trainer integrates personal growth and professional development into a collaborative environment of participants 104 to enhance the physical fitness training.

In one embodiment, the motivational system 100 may be organized and systemized to enable a personal trainer or the like to easily administrate the motivational program 100 in a working environment or in a group environment. The motivational system 100 may provide the basic framework that enables a personal trainer or the like to provide personalized physical fitness instruction over a computer network and to integrate personal growth and professional development in a collaborative accountable environment.

The administrator 102, in certain embodiments, develops the plan 103. The administrator 102 may be an individual who administrates the motivational system 100 as discussed. Alternatively, the administrator 102 may be an automated control system or the like configured to develop and distribute one or more personalized plans 103 to participants 104. In a further embodiment, the administrator 102 may comprise a combination of one or more automated systems and one or more individuals. In certain embodiments, the administrator 102 combines selected information, such as physical fitness instruction and personal growth and professional development directives, to create the plan 103 in order to promote optimal wellness. The plan 103 may be developed from input received from the participant 104.

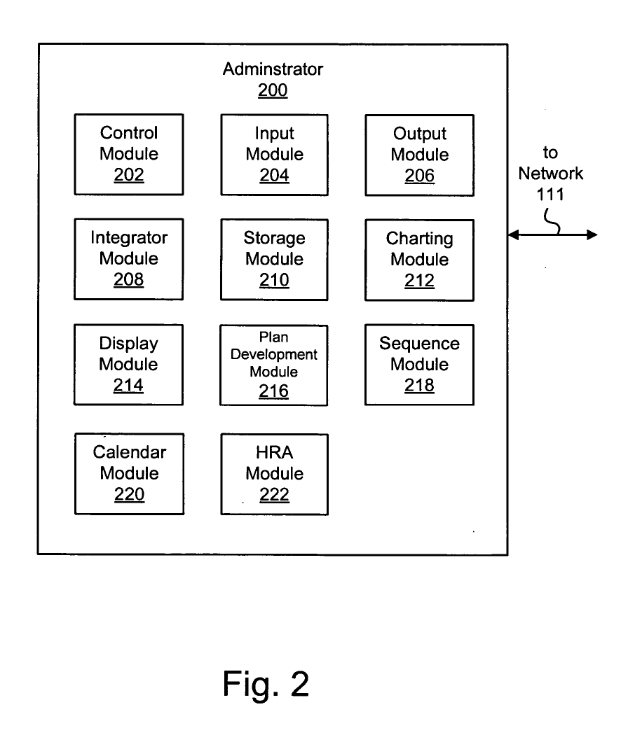

FIG. 2 illustrates in greater detail one embodiment of an automated administrator 200. As depicted, the administrator 200 includes a control module 202, an input module 204, an output module 206, an integrator module 208, a storage module 210, a charting module 212, a display module 214, a plan development module 216, a sequence module 218, a calendar module 220, and a health risk assessment module 222. In certain embodiments, the administrator 200 receives input from one or more participants 104 and develops a personalized plan 103 in response to the input received by the input module 204. The plan 103 may be distributed over the computer network 111.

The control module 202 monitors the activity of the other modules. The input module 204 and the output module 206 enable the administrator 200 to send and receive communications from one or more participants 104. In certain embodiments, the output module 206 may be configured to generate emails to communicate with the participants 104. In addition, the input module 204 may be configured to receive input, such as a questionnaire, a registration form, a response, or the like, from the participant 104. The input may used to develop a personalized plan 103, to enhance a website 112, to schedule an event, or the like.

The integrator 208 enables integration of physical fitness instruction, directives for personal growth and professional development, and the like with the input received from the participant 104. As a result, the plan 103 may be customized to the participant(s). Furthermore, the physical fitness instruction may be enhanced with personal growth and professional development directives.

The storage module 210 enables storage and retrieval of information for integration and distribution. In addition, the storage module 210 may store additional resources such as a media library, website links, information and/or videos for download, and the like.

The charting module 212 enables charting input, participant responses, goals, and the like for viewing. The charting module 212 may be configured to create multiple charts or the like to measure or determine different aspects of the motivational/physical fitness program. For example, the charting module 212 may be configured to chart participation, biometrics, comparisons, and the like.

The display module 214 enables generation of a viewable display. In certain embodiments, the display is viewable on a webpage. In an alternative embodiment, the display may be a graphics file.

The plan development module 216 enables development of an organized plan 103 from available resources and files. In certain embodiments, the plan development module 216 enables the plan 103 to be updated relative to a response received from the participant 103.

The sequence module 218 enables additional information, resources, videos, directives and the like to be added sequentially to a developed plan 103 without disrupting the plan 103 or recreating a new plan 103. The sequence module 218 may further be configured to sequence personal growth and business development directives relative to a request or demand. In one embodiment, the sequence of the personal growth and professional development directives is ordered according to a request from a participant 104, group 106, department 108, or company 110.

The calendar module 220 enables scheduling of events. In particular, the calendar module 220 may determine the timing to control internal processes, for example, such as when to update a plan 103 and when to introduce a new sequence of informational material. In addition, the calendar module 220 may be configured to synchronize events, such as meetings for a group, an online class, or the like.

The health risk assessment module 222 may be configured to receive input from a participant and to determine the participant's health risk for common conditions, such as cardiovascular disease, diabetes, and the like. Performing a health risk assessment may enable at risk participants 104 to make lifestyle changes to avoid further problems. In one embodiment, the health risk assessment module 222 is further configured to compare the results of multiple participants. Consequently, a company 110 or the like may be able to assess the overall health of employees or the like in order to implement changes to increase the wellbeing of the individuals and the company. The names of individuals may be withheld to protect their privacy. In one embodiment, the health risk assessment is derived from forty-four to fifty-two questions answered by the participant 104.

The computer network 111, in certain embodiments, provides an external structure to disseminate information to a participant 104. Multiple participants 104 may communicate with the administrator 200 and/or with each other. In select embodiments, the network 220 enables participants 104 to view their personalized plan 103 as well as all or part of others' personalized plans 103, thereby enabling participants 104 to support one another in their goals.

In one embodiment, the plan 103 provides physical fitness instruction based on a personal profile, a personalized heart rate workout provided by the participant 104, and any participant preferences. The personal profile may include information identifying the participant's physical fitness level and any known health conditions. In addition, the personal profile and/or preferences may further include individual goals and business development needs. The heart rate workout provides specific information to develop a personalized fitness program. The preferences may include preferred types of exercises or dislikes to enable the administrator 200 to determine the best fitness plan 103 for the participant 104 as well as the best approach to integrate directives for personal and professional needs.

The administrator 200 may further provide the participant 104 with a tailored plan 103 in the area of personal growth and professional development specified by the participant's company 110 and/or department 108. In certain embodiments, the administrator 200 receives input from a group 106, 108, 110 that may include information such as goals, weaknesses, areas for improvement, etc. The input may facilitate determining a tailored plan 104 designed for a group of participants 104. The tailored plan 103 may include instructions for both physical fitness and personal growth and professional development.

Specific exercises in a plan 103 may be selected according to a reported fitness level of the participant 104. The participant 103 may subsequently respond to the administrator 200 to request a more difficult or simpler prescribed workout regime. In certain embodiments, the plan 103 includes a questionnaire, a report, or the like in order to facilitate receiving a participant response for reporting progress, results, concerns, or the like. The participant response may require the participant 104 to report goals, both short-term and long-term. In addition, the participant response may enable the participant 104 to select whether to continue receiving additional information and/or plans 103. The participant 104 may further determine the type of information and/or plans 103 received. Selected information and/or plans 103 may be altered according to the progress and/or response of the participant 104.

The physical fitness instruction, in certain embodiments, may be directed to a working environment or to a specific lifestyle. In one embodiment, instructions are emailed to the participant 104 in Portable Digital Format. Alternatively or in addition, the participant 104 may be emailed one or more video web links. In one embodiment, the prescribed exercises may be done while sitting at a desk, and the participant 104 may complete the exercises without changing clothes or using specialized equipment. In addition, based on the participant's heart rate workout, the plan 103 may select exercises to help the participant 104 achieve a desired fitness goal using target heart rate zone training.

For example, the physical fitness instruction may include a daily or weekly goal for achieving weight loss by obtaining a certain amount of time in the participant's target heart rate zone. Instruction may also include achieving weight loss by walking a certain number of steps using a pedometer. Information and/or instructions may further include known approaches to physical fitness, such as cardiovascular exercise and strength and flexibility training. Of course, those of skill in the art will recognize that physical fitness instruction may include information regarding various types of trainings based on different philosophies, research and theories. The participant 104 may be able to select a type of fitness approach in certain embodiments. In an alternative embodiment, a personal trainer may prefer a certain style of training. In order to select a type of training, the participant 104 may select a preferred personal trainer. In one embodiment, cardio workouts are rotated every two weeks.

The plan 103 may provide a constructive form of feedback and may include opportunities for the participant 104 to account for his or her progress. In one embodiment, the response of the participant 104 is charted and returned to the participant 104. In a further embodiment, the charted results are additionally sent to people identified as “buddies.” Fitness buddies or fitness groups 106 may be allowed to view each others' progress. As a result, participants 104 may be able to share successes and to encourage each other to continue to progress. The charts may be sent by email to the participant, or alternatively, the charts may be viewed on a website 112.

In a further embodiment, participants' charted results and/or goals 128 are accumulated and separated into various departments 108 and/or companies 110. The accumulative results may reflect a company's progress as a whole. The charts help build camaraderie and encourage participant progress. Charts may be viewable to participants 104 of the departments 108 and/or company 110. In one embodiment, participant responses and goals are charted on a weekly basis. The plan 103 may also be modified on a regular basis if necessary.

A calendar may facilitate distribution of the plan 103 and displaying charts 114, 115, 118, 120. For example, a participant 104 may elect to receive a heart rate workout on Mondays, Wednesdays, and Saturdays. Subsequently, the participant 104 may report his/her results on Sunday. The charts 114, 115, 118, 120 may be updated every Monday in one plan 103. In an alternative embodiment, the charts 114, 115, 118, 120 may be updated when information is received. Those of skill in the art will recognize that calendars, charts, workouts, plans 103 and the like may be adjusted to meet the needs of the participant 104 and/or the administrator 200.

FIG. 3 illustrates one embodiment of a membership website 300 in accordance with the present invention. The membership website 300 enables a community of participants 104 to collaborate through a network 111 such as the internet. In addition, a membership fee or the like may be required before enabling a login 302 to enter the website 300. Furthermore, services, downloads, or the like may be available for an additional fee or through a subscription to an advanced membership level. The membership website 300 may further enable the participant 104 to search the website or to participate in special online events.

The membership website 300, as depicted, comprises a login 302, a registration 304, a participant chart 306, a group chart 308, information 310 for personal growth and professional development, information 312 for physical fitness, videos 314, goals 316, a web forum 318, video conferencing or web cam 320, scheduled teleseminars and telecoaching 322, online chat 324, personalized information 326, awards/prizes 328, a fitness challenge 330, an online class 332, a shopping cart 334, a calendar 336, a health risk assessment 338 test, contact information 340, downloads 342, and streaming capabilities 344.

The registration 304 may include participant input, such as a questionnaire and defined goals 316, for example, that facilitates developing the plan 103. In addition, the registration information may be used to track a user account or the like. In certain embodiment, the participant 104 may be able to select a screen name to post a message, to join the web forum 318, to chat 324, and/or to participate in other special online events such as voting for a favorite workout, participating in an online class 332 or fitness group, taking part in a fitness challenge 330, or participating in contests for awards and prizes 328. In certain embodiment, the screen name may be associated with an email address.

In one embodiment, the membership website 300 may include a mechanism or special offer to attract new participants 104. For example, the website 300 may offer a free workshop received via email in order to capture an individual's email address. If the individual fails to return to join the membership website 300, an invitation or special offer may be generated and sent to the email address to invite new participants 104. Once participants 104 join the membership website 300, a welcome packet may be sent to the participant 104 containing basic equipment, such as a heart rate monitor, workout mat, or the like. The participant 104 may also receive a welcome email explaining the details of the program. In certain embodiments, the welcome email may contain a basic plan 103 developed from the registration information.

As mentioned, the website 300 may be administrated by a personal trainer in certain embodiments. In such an embodiment, the personal trainer may schedule time to participate on the web forum 318, to chat 324 with participants, to video conference or meet through web cam 320, to answer questions, or to schedule a telecoaching session 322 one-on-one with the participant 104. In one embodiment, the participant 104 may receive a weekly phone call from the personal trainer to follow up on progress and goals. After about a month, the participant 104 may receive monthly calls.

Telecoaching sessions 322 and the like may be posted on the calendar 336 as a reminder to the participant 104. Participant input may also be posted on the calendar 336 in certain embodiments. In one embodiment, the participant provides a basic personal schedule during the registration 304 process. Workouts may be emailed to the participant 104 according to the participant's schedule.

The personal trainer may use the website 300 to teach principles for physical fitness and to disseminate information 310 about personal growth and professional development. In one embodiment, the participants may post topics about which they would like to learn. Subsequently, a teleseminar 322 may be scheduled to address the chosen topic. Professional motivational speakers, consultants, specialists, or the like may be invited to participate in the teleseminar 322. Thus, the participants 104 are provided an opportunity to increase their knowledge about any area of personal growth and professional development from experts in those fields. Contact information 340 may be provided on the website 300 to enable participants 104 to reference products, seminars, or other information related to the featured presenters. In certain embodiments, an additional fee may be associated with the teleseminars 322 and the contact information 340.

In certain embodiments, the shopping cart 334 functions to vend popular products to the participants 104, such as printed media, exercise equipment, videos, or the like. In certain embodiments, the website 300 features the presenter's products.

The website 300 may also provide a sign up for fitness cruises, fitness cleanses, vacations, or the like. A participant's progress in the program may determine the participant's eligibility in certain embodiments. In addition, fitness “buddies” or groups 106 may be able to meet in person through special events to build friendships and camaraderie.

To motivate the participants 104 and to personalize the fitness program, the website 300 may enable participants 104 to personalize a workout 326 or the like. For example, a participant may choose a name for a workout that has special meaning or that is comical. The workouts may be named after inspirational people or ideas to overcome negative feelings or ideas about workouts. Enabling the participant 104 to personalize aspects of the fitness and motivation program enables the participant 104 to feel included, welcomed, and supported while participating in the program.

As another bonus for the fitness and motivational program, online classes 332 may be available through the website 300. The class 332 may be presented live through streaming 344 or the like. Alternatively, the class 332 may be recorded. In one embodiment, the participants 104 may login or the like such that other participants 104 are aware of the participants 104 joining the class 332. A participant's screen name may be listed in certain embodiments.

In addition to online classes 332, the website 300 may provide information 310, 312 for other programs available to overcome specific problems. For example, links or references may be available to facilitate obtaining information to quit smoking, to overcome addictions, to deal with personal problems, or the like.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Additionally, the order in which a particular method occurs may or may not strictly adhere to the order of the corresponding steps shown.

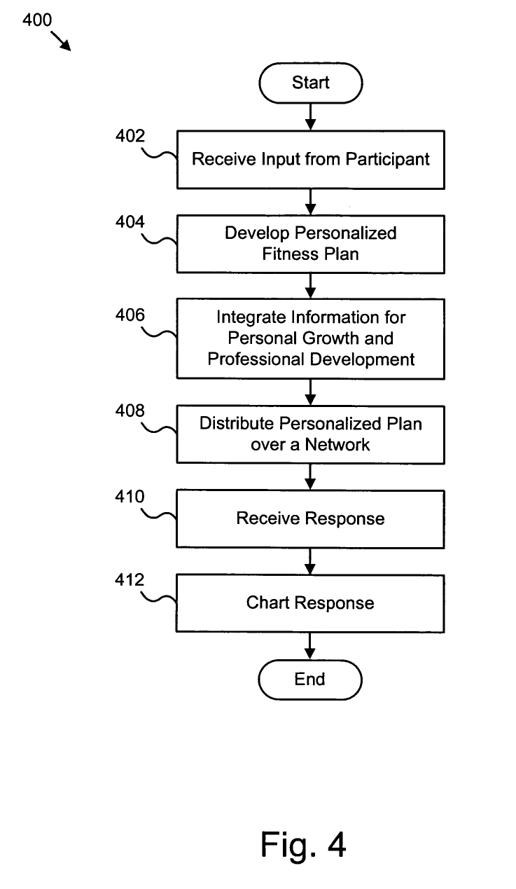

FIG. 4 illustrates one embodiment of a plan development method 400. The plan development method 400 enables the creation and distribution of a personalized improvement plan 103 to the participant 104 over a computer network 111. As depicted, the plan development method 400 may include receiving 402 input from a participant 104, developing 404 a personalized fitness plan 103, integrating 406 information for personal growth and professional development with the fitness plan 103, distributing 408 the personalized plan 103 over a computer network 111, receiving 410 a response from the participant 104, and charting 412 the response.

In one embodiment, the input may include personal information about health and personal interests. A form, such as an internet webpage with a designated fill-in area or the like, may further prompt a participant 104 to include information about personal goals, habits, relationship skills, professional interests, and the like. In one embodiment, a personal information input form is compiled with regard to a specific program, such as a fitness program or a goal-setting program, and includes questions directed to receiving a related response. An administrator 102 may subsequently receive 402 the input.

The administrator 102 may use the input to develop 404 a personalized plan 103, such as a fitness plan 103. The fitness plan 103 may be based off of the information provided by the participant 104. In one embodiment, the personal fitness plan 103 provides a suggested course of action to achieve a greater fitness level. Additionally, the administrator 102 may integrate 406 information for personal growth and professional development with regard to the information provided by the participant 104. For example, if the participant 104 reports an interest in developing communication skills, the plan 103 may include information or suggestions for improving communication skills and a way to measure improvement.

The administrator 102 may distribute 408 the personalized plan and the integrated information over a computer network 111 such as the internet. In one embodiment, the personalized plan 103, including workout videos and personal growth and business development videos and related information, is sent to a participant 104 via email. Additional related information, such as videos and the like, may be available to the participant 104 for download from a website 112, 300.

In one embodiment, the administrator 102 may selectively send a short video clip focusing on a requested topic of interest to a participant 104. The clip may include a professional speaker offering free advice and a brief introduction. Additionally, the clip may include contact information to receive more information. In one embodiment, additional literature, videos, promotional information, and the like may be available for sale and/or download from the website 112, 300. In certain embodiments, the featured speakers may pay a fee to post information and the like to the website 112, 300 and/or to distribute promotional information through the computer network 111. Alternatively or in addition, a percentage of the revenue may be required to continue posting and/or distributing the information. The information may encourage and motivate a participant 104 to achieve desired goals.

A participant 104 may receive motivational and professional materials based off of feedback provided to the administrator 102. In one embodiment, the participant 104 selects one or more areas of focus for personal growth and professional development. The administrator 102 may subsequently organize a sequenced program to promote learning and development. For example, if a participant chooses to focus on positive thinking, relationship skills, networking, and branding information, the administrator 102 may provide to the participant 104 an informational tip and/or video clip showcasing each of those topics sequentially, thereby ensuring that each of the areas of focus are addressed. A company 110 or department 108 may request specific tailored personal and professional information for its participants 104, which are then sequenced by the administrator 102 into the participant's plan 103.

Professional speakers may be sequenced, according to one embodiment, such that a first speaker presents a first tip A on positive thinking, for example. Then when the topic of focus cycles back to positive thinking, a second speaker gives his/her first tip A. When all the available speakers have presented their first tip A, the administrator 102 may sequence back to the first speaker to present the first speaker's second tip B on positive thinking and so forth. If a new speaker is added to the sequence, the new speaker may be scheduled at the end of the presenting speakers to present his/her first tip A. Thus, presentations and materials are kept organized and fresh for the participant 104.

In order to maintain a personalized plan 103, the information sent to the participant 104 may provide a way for the participant 104 to respond to the administrator 102. For example, a response form or the like may be included with a communication from the administrator 102 to help the participant 104 evaluate and/or report the results of the personalized plan 103. For example, a participant 104 may report if an exercise was completed or a video viewed and whether the particular exercise or video was helpful. In addition, personal progress and goals may also be reported. The response may be used to modify the plan 103.

In addition, the administrator 102 may receive 410 the participant's response and chart 412 the response. In one embodiment, the administrator 102 charts the measurements of the participant 104. In a further embodiment, the administrator 102 charts physical fitness goals and the actual results, such as a number of steps walked, time spent in target heart rate zone, and weight loss, or body measurements achieved. In certain embodiments, the administrator 102 may chart more than one participant 104 on a single chart. Consequently, other participants 104 may view their personal results and compare their progress with other's progress. In one embodiment, the results may only be viewed by those designated as a “buddy,” or in other words, those authorized to view the results. Charting results motivates the participant not only with a sense of accountability, but also with a sense of community, where multiple users are encouraging and motivating each other to reach a desired goal.

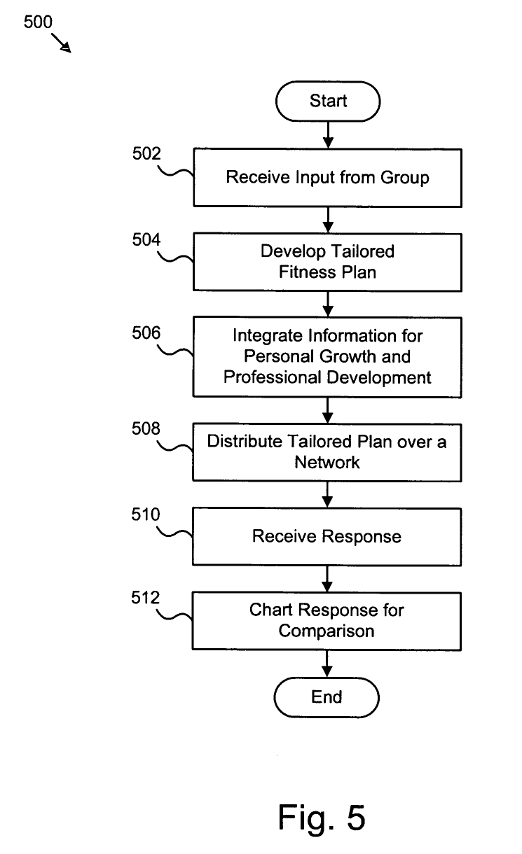

FIG. 5 illustrates an alternative embodiment of a plan development method 500. The plan development method 500 enables a group of participants 104, such as groups 106, 108, 110 of FIG. 1, for example to compete against another group 106, 108, 110 as part of a motivational program. The plan development method 500 may include receiving 502 input from a group 106, 108, 110 of participants 104, developing 504 a tailored fitness plan 103, integrating 506 information for personal growth and professional development, distributing 508 the tailored plan over a computer network 111, receiving 510 a response, and charting 512 the response for comparison.

The plan development method 500 may be administrated similar to the plan development method 400 described above with respect to FIG. 4. The plan development method 500, however, further enables the administrator 102 to develop a plan 103 with goals for the group of participants 104. Consequently, the group of participants 104 may be motivated to achieve personal and group goals in order to compete against other groups.

In one embodiment, a department 108 within a company 110 may be defined as a group. The department 108 and/or the participants 104 within the department 108 of the may provide input to the administrator 102. Subsequently, the administrator 102 may receive 502 the input and develop 504 a tailored plan 103 for the department 108 to achieve a specific goal, such as an accumulated number of steps per week or a total number of pounds lost, for example. The administrator 102 may also receive 502 the input and develop 504 a tailored plan 103 for the entire company 110 to achieve a specific weight loss goal or other goal in which all participants 104 contribute to the desired goal.

The administrator 102 may integrate 506 tailored information for personal growth and professional development into the plan 103 and distribute 508 the tailored plan 103 over a computer network 111. In certain embodiments, the administrator 102 implements the tailored plan 103 and facilitates peer support and professional collaboration within the selected group 106. As mentioned, the administrator may be a personal trainer in select embodiments.

In one embodiment, a company representative, a department representative, and/or a participant 104 may request a desired type of personal growth and professional development information. Thus, the needs of the department 108, company 110, group 106 or the like may be met in areas of physical fitness as well as personal growth and professional development by following the integrated plan 103.

The participants 104 of the department 108, or group, may respond to the plan 103, and the administrator 102 may receive 510 the response. The administrator 102 may subsequently chart 512 the response. The chart may further be distributed to participants 104 within a department 108, to participants 104 within the company 110, and/or to selected participants 108. A website 112, 300 may facilitate motivating the department 108 and encouraging progress. Various charts 114, 116, 118, 120 posted on a website 112, 300 may facilitate viewing and comparing the results.

In certain embodiments, the administrator 102 receives input for a health risk assessment and subsequently provides health risk statistics for the group. For example, the health risk assessment may determine the number of participants 104 at risk for heart disease within a department 108. The results may be charted for the group to view. Comparisons may motivate participants 104 to make constructive changes in their lifestyles. In addition, the department 108 and/or the group 106 may gain a better understanding of the health condition of the participants 104 within the group 106.

In addition, the viewable charts may be used to compare the results of different departments 108 within a company 110. A winning department 108 may be awarded special benefits for achieving better results than another department 108. Consequently, participants 104 within a company 110 are provided with a developed motivational plan 103 to achieve improvement, whether physical, emotional, professional, social, etc. Measurable improvements may be charted to encourage all within the company 110 to achieve greater levels of excellence. As a result, the participants 104 within a company 110 may have greater success, productivity, unity, and camaraderie.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer program product comprising a computer readable medium having computer usable program code programmed for providing personalized physical fitness instruction and integrating personal growth and professional development in a collaborative accountable environment, the operations of the computer program product comprising:
receiving input from a participant in a selected group and developing a personalized plan in response to the input, wherein the personalized plan comprises physical fitness instruction and at least one directive for personal growth and professional development;
distributing the personalized plan to at least one participant of the selected group through a computer network; and
receiving a response from the participant and charting the response for viewing by a plurality of participants in the selected group.

2. The computer program product of claim 1, wherein the operations further comprise receiving input from an administrator.

3. The computer program product of claim 2, wherein the administrator is selected from the group consisting of a personal trainer, an automated control system, and a combination of a personal trainer and an automated control system.

4. The computer program product of claim 1, wherein the physical fitness instruction and at least one directive for personal growth and professional development are accessible through a website.

5. The computer program product of claim 4, wherein the website is configured to be a membership website.

6. The computer program product of claim 1, wherein the physical fitness instruction and at least one directive for personal growth and professional development are configured to be transmitted through one of email, internet streaming, download, teleseminar, videoconference, telephone, online class, video, internet website, and web cam.

7. The computer program product of claim 1, wherein the operations further comprise sequentially integrating files comprising at least one directive for personal growth and professional development with the physical fitness instruction.

8. The computer program product of claim 1, wherein the operations further comprise charting goals and results for viewing and comparison.

9. The computer program product of claim 1, wherein the operations further comprise providing a health risk assessment and determining and reporting the results.

10. The computer program product of claim 1, wherein receiving input from a participant comprises receiving a personal profile and a determined physical fitness level.

11. The computer program product of claim 1, wherein the operations further comprise altering a personalized plan according to the response of the participant.

12. A method for providing personalized physical fitness instruction and integrating personal growth and professional development in a collaborative accountable environment, the method comprising:
receiving input from a participant in a selected group and developing a personalized plan in response to the input, wherein the personalized plan comprises physical fitness instruction and at least one directive for personal growth and professional development;
distributing the personalized plan to at least one participant of the selected group through a computer network; and
receiving a response from the participant and charting the response for viewing by a plurality of participants in the selected group.

13. The method of claim 12, further comprising communicating with the participant.

14. The method of claim 13, wherein communicating with the participant further comprises initiating correspondence through one of email, chat, telephone, web forum, teleseminar, online class, web cam, and videoconference.

15. The method of claim 12, wherein an individual communicates with the participant to motivate the participant.

16. The method of claim 12, further comprising providing contact information to the participant to obtain additional information for personal growth and professional development, wherein a fee is associated with providing the contact information.

17. A method for providing personalized physical fitness instruction and integrating personal growth and professional development in a collaborative accountable environment, the method comprising:
receiving information from a selected group of participants belonging to a larger defined group and developing a tailored plan in response to the information, wherein the tailored plan comprises physical fitness instruction and personal growth and professional development information;
distributing the tailored plan to at least one participant of the selected group through a computer network;
receiving a response from the selected group of participants belonging to a defined larger group; and
charting the response for comparison with another selected group of participants belonging to the larger defined group.

18. The method of claim 17, wherein the selected group comprises individuals employed in a working environment.

19. The method of claim 17, wherein the tailored plan is configured to provide personal growth and professional development information requested by one of a company representative, a department representative, and a participant.

20. The method of claim 17, wherein an administrator implements the tailored plan and facilitates peer support and professional collaboration within the selected group.
